(19) United States
(12) Patent Application Publication
(10) Pub. No.: US 2015/0188968 A1
(43) Pub. Date: Jul. 2, 2015

(54) ELECTRONIC DEVICE AND PLAYBACK METHOD OF STREAMING MEDIA THEREOF

(71) Applicant: ASUSTeK COMPUTER INC., Taipei City (TW)

(72) Inventors: Hsin-Yi Lee, Taipei City (TW); Da-Li Lai, Taipei City (TW); Zheng-Hong Luo, Taipei City (TW); Shou-Pin Hsu, Taipei City (TW)

(21) Appl. No.: 14/586,981

(22) Filed: Dec. 31, 2014

Related U.S. Application Data
(60) Provisional application No. 61/923,198, filed on Jan. 2, 2014.

(30) Foreign Application Priority Data
Dec. 29, 2014 (CN) 201410837579.7

(51) Int. Cl. H04L 29/06; H04W 4/00

(52) U.S. Cl. CPC H04L 65/60; H04W 4/008

(57) ABSTRACT

An electronic device and a playback method of streaming media thereof are provided. The electronic device is within the local area network (LAN), and a media server and a plurality of playback devices are also within the LAN. The media server provides the streaming media to a first playback device for playback. The electronic device includes a first communication unit, a second communication unit and a processing unit. The second communication unit is connected to the media server via the LAN. When the first communication unit is connected with the first playback device based on a first communication protocol, the processing unit receives the playback information of the streaming media, and when the first communication unit is connected with a second playback device based on a second communication protocol, the processing unit transmits the playback information to the second playback device to continue playing of the streaming media.

### CROSS-REFERENCE TO RELATED APPLICATION

This application claims the priority benefits of U.S. provisional application Ser. No. 61/923,198, filed on Jan. 2, 2014 and Chinese application serial no. 201410837579.7, filed on Dec. 29, 2014. The entirety of each of the above-mentioned patent applications is hereby incorporated by reference herein and made a part of specification.

### BACKGROUND OF THE INVENTION

1. Field of the Invention

The disclosure relates to a media playback technology and, more particularly, to a playback method of streaming media.

2. Description of the Related Art

Digital Living Network Alliance (DLNA) is a transmission standard defined by multiple companies, and it allows media devices of different brands or different types to communicate and transfer data with each other. Moreover, via the DLNA technology, contents of digital media such as the streaming media can be shared among electronic devices which can play digital media files in a local area network (LAN), such as a computer, a mobile phone or a tablet computer.

Conventionally, to play the digital media based on the DLNA, the user should search a matched device in the LAN wiredly or wirelessly via a user interface displayed on a digital media controller. After the device is found, the user further searches the media to play, and the process is rather time-consumed and inconvenient. When the user wants to switch current playback media content to another device for playback but the device cannot be found instantly, the fluency while playing is disturbed which causes a poor using experience.

### BRIEF SUMMARY OF THE INVENTION

An electronic device and a playback method of streaming media are provided to switch the streaming media among different devices, and the streaming media can be continuously played without complicated manual settings.

An electronic device is provided. The electronic device is connected to a LAN, and a media server and a plurality of playback devices are also connected to the LAN. The playback devices are connected to the media server via the LAN, and the media server provides the streaming media to a first playback device of the playback devices for playback. The electronic device includes a first communication unit, a second communication unit and a processing unit. The second communication unit is connected to the media server via the LAN. The processing unit is coupled to the first communication unit and the second communication unit. When a connection is established between the first communication unit and the first playback device based on a first communication protocol, the processing unit receives playback information of the streaming media via the first communication unit, and when the connection is established between the first communication unit and a second playback device of the playback devices based on a second communication protocol, the processing unit transmits the playback information to the second playback device via the first communication unit, so as to control the second playback device to continue playing the streaming media according to the playback information.

A playback method of streaming media is also provided. The playback method is applied to an electronic device, a media server and a plurality of playback devices are connected in an LAN. The playback devices are connected to the media server via the LAN, and the media server provides the streaming media to a first playback device of the playback devices for playback. The playback method of the streaming media includes following steps: establishing a connection between the LAN and each of the electronic device, the media server and the playback devices; receiving playback information of the streaming media when a connection is established between the electronic device and the first playback device based on a first communication protocol; and transmitting the playback information to a second playback device of the playback devices when the connection is established between the electronic device and the second playback device based on a second communication protocol, so as to control the second playback device to continue playing the streaming media according to the playback information.

As stated above, via the electronic device and the playback method of the streaming media thereof, the playback information of the streaming media can be transmitted between two devices via the NFC technology. Thus, the streaming media can be guided to another device for continuous playing. Consequently, complicated manual settings are not required, and the time to search another device for playback is reduced.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic system in an embodiment;

FIG. 2 is a block diagram showing an electronic device in an embodiment;

FIG. 3 is a flow chart showing a playback method of streaming media in an embodiment;

FIG. 4 is a schematic diagram showing a playback method of streaming media in an embodiment; and

FIG. 5 is a schematic diagram showing a playback method of streaming media in an embodiment.

### DETAILED DESCRIPTION OF THE EMBODIMENTS

An electronic device and a playback method of streaming media thereof in embodiments are applied to a digital living network alliance (DLNA) architecture. Two different devices can communicate with each other when they approaches each other via near field communication (NFC) technology, and the streaming media played on a device can be continuously played on another device. Consequently, it does not need complicated manual settings.

In an embodiment, according to user requirements and configurations of devices, the electronic device further cooperates with other communication protocols to guide the streaming media to make sharing of the media more convenient. The disclosure is illustrated with following embodiments.

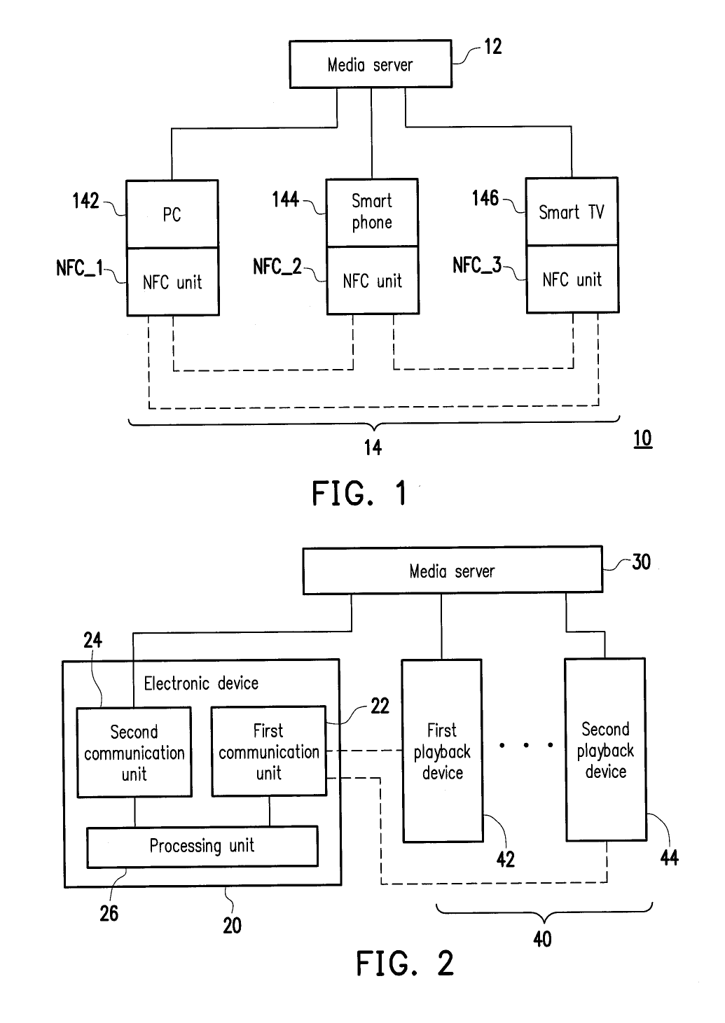

FIG. 1 is a schematic diagram showing an electronic system in an embodiment. The electronic system 10 includes a media server 12 and a plurality of electronic devices 14, such as a personal computer (PC) 142, a smart phone 144, or a smart television (TV) 146. The media server 12 may be a digital media server which supports the DLNA standard, and the electronic devices 14 may be digital media players, digital media controllers or digital media renders which support the DLNA standard.

In the embodiment, the way of establishing a connection between the electronic devices 14 include setting a build-in NFC module (such as the NFC unit NFC_2 of the smart phone 144), connecting an external NFC module (such as an external NFC hardware kit of the PC 142, which includes an NFC unit NFC_1), or external settings (such as writing the device identity (ID) of the smart TV 146 to an NFC chip, wherein the NFC chip is regarded as the NFC unit NFC_3 of the smart TV 146). Thus, when one of the electronic devices (such as the smart phone 144) approaches another electronic device (such as the PC 142), the electronic devices can transfer data to each other via the NFC units NFC_2 and NFC_1. The NFC connection between the electronic devices 14 is shown in dotted lines in FIG. 1.

For example, the user uses the PC 142 to play the streaming media stored in the media server 12. If the user wants to leave the PC 142, the user puts the NFC unit NFC_2 of the smart phone 144 close to the NFC unit NFC_1 of the PC 142 to establish a connection, and then the smart phone 144 obtains the playback information via the NFC connection, for example, the playback information is the current playback time point of the streaming media played on the PC 142 and the storage address of the streaming media in the media server 12. Then, the smart phone 144 obtains the streaming media from the media server 12 according to the playback information, and the smart phone 144 continues playing the streaming media. If the user wants to play the digital media on the smart TV 146, similarly, the user can put the NFC unit NFC_2 of the smart phone 144 close to the NFC chip (which is the NFC unit NFC_3) which records the device ID of the smart TV 146 to establish a connection, and the digital media played on the smart phone 144 is switched to the smart TV 146 for seamless playing.

In the embodiment, the playback information of the streaming media is transmitted via the NFC connection, which is not limited herein. In other embodiments, the smart phone 144 can receive the playback information via the NFC connection first and then transmits the playback information to the smart TV 146 via infrared (IR) transmission to achieve a remote control function. In other words, a connection between the smart phone 144 and other devices can be established via another communication protocol, instead of LAN, to transmit the playback information. In the DLNA architecture, the browsing request of the digital media transmitted to the media server 12 and the response from the media server 12 are transmitted via LAN, and the transmission is affected by the network bandwidth. In the embodiment, the playback devices can be switched more rapidly and more intuitively, so as to achieve the continuous playing between different devices.

The electronic device and the playback method of the streaming media thereof are further illustrated with following embodiments.

FIG. 2 is a block diagram showing the electronic device in an embodiment. Please refer to FIG. 2, in the embodiment, the electronic device 20 is a hardware device (such as a digital media player, a digital media controller or a digital media render) which supports the DLNA standard and can play the DLNA standard media, such as a TV, a stereo system, a PC or a portable electronic device (which includes a notebook computer, a mobile phone, a personal digital assistant (PDA), a digital video camera and a digital camera). The electronic device 20 is in the LAN, and the media server 30 and a plurality of the playback devices 40 are also in the LAN. The playback devices 40 are connected to the media server 30 via the LAN. In the embodiment, the playback devices 40 include the first playback device 42 and the second playback device 44. The LAN may be a wireless or wired network, such as one or a combination of the Ethernet and a wireless network based on the IEEE 802.11 standard, which is not limited herein.

The media server 30 is a hardware device which supports the DLNA standard and provides a DLNA standard media server function, such as a PC, a network storage media, a digital video tape recorder (VCR) or a portable electronic device (such as a notebook computer, a mobile phone, a personal digital assistant (PDA), a digital video camera and a digital camera). Similar with the electronic device 20, the playback device 40 is a digital media player, a digital media controller or a digital media render that can play a DLNA standard media.

In the embodiment, the electronic device 20 includes a first communication unit 22, a second communication unit 24 and a processing unit 26.

In an embodiment, the first communication unit 22 is a transmission module which conforms to the NFC protocol. The first communication unit 22 includes an NFC antenna and executes a non-contact point-to-point (P2P) data transmission at an active mode or a passive mode. In detail, the electronic device at an active mode includes a battery and generates an exclusive radio frequency (RF) field to transfer data. In an embodiment, as shown in FIG. 1, the PC 142 includes the active mode NFC unit NFC_1, and the smart phone 144 includes the active mode NFC unit NFC_2, when the NFC unit NFC_1 of the PC 142 approaches the NFC unit NFC_2 of the smart phone 144, the NFC unit NFC_1 sends an RF signal to the NFC unit NFC_2, and the NFC unit NFC_2 sends a signal with a same frequency to the NFC unit NFC_1. Then, the two NFC units process the signals, and a P2P connection is established via their exclusive RF field, respectively.

On the other hand, in an embodiment, the NFC unit NFC_3 of the smart TV 146 transfers data at a passive mode, and the NFC unit NFC_3 stores an NFC tag. In the communication between the NFC unit NFC_2 of the smart phone 144 and the NFC unit NFC_3 of the smart TV 146, the NFC unit NFC_2 provides an RF field to transfer data to the NFC unit NFC_3, and the NFC unit NFC_3 can send back the data at a same speed via a load modulation technology. In the data transmission, the message encapsulation format is defined by the specification of the NFC data exchange format (NDEF), so as to exchange the identifying information of the devices or the data more smoothly.

In an embodiment, the first communication unit 22 includes other transmission modules which conform to other communication protocols, such as IR transmission or radio transmission, which is not limited herein. Thus, a connection is established between the electronic device 20 and other playback devices 40 at different communicating modes according to the communication protocol of the first communication unit 22.

The second communication unit 24 may be a wireless fidelity (Wi-Fi) module, a worldwide interoperability for microwave access (WiMAX) module or a blue-tooth module. The second communication unit 24 is connected to the media server 30 via the LAN to support the wireless transmission of the streaming media.

The processing unit 26 is coupled to the first communication unit 22 and the second communication unit 24. The processing unit 26 may be one or a combination of a central processing unit (such as a central processor or a platform control hub), a programmable microprocessor, a digital signal processor (DSP), a programmable controller, and an application specific integrated circuit (ASIC).

In an embodiment, the processing unit 26 cooperates with a control assembly, and controls the media files of the same streaming media to be switched between different devices via the control assembly. In an embodiment, the processing unit 26 controls the media files of the same streaming media to be played at two devices at the same time, which is not limited herein.

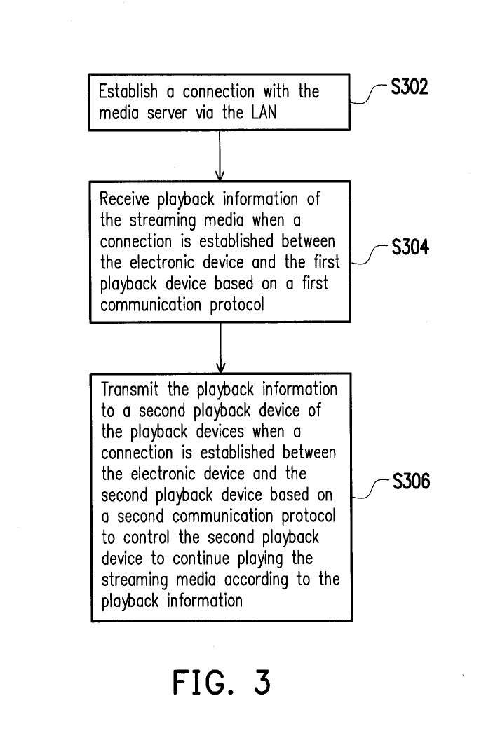

Based on the system architecture, a playback method of the streaming media is illustrated with following embodiments. FIG. 3 is a flow chart showing a playback method of the streaming media in an embodiment, and the method is applied to the electronic device 20 in FIG. 2. The method is described with the components shown in FIG. 2.

First, in the step S302, the second communication unit 24 is connected to the media server 30 via the LAN, and the media server 30 provides the streaming media to the first playback device 42 of the playback device 40 for playback. In the step S304, when a connection is established between the first communication unit 22 of the electronic device 20 and the first playback device 42 based on the first communication protocol, the processing unit 26 receives the playback information of the streaming media via the first communication unit 22.

In detail, in the embodiment, the first communication protocol is the NFC protocol, the first communication unit 22 includes an NFC unit, and the first playback device 42 includes a corresponding NFC unit (not shown), such as a built-in or an external NFC unit, or an external chip. When the first communication unit 22 approaches the NFC unit of the first playback device 42, the processing unit 26 receives the identification data of the first playback device 42 via the first communication unit 22 to establish an NFC connection with the first playback device 42, and the processing unit 26 receives the playback information of the streaming media via the NFC connection.

The identification data includes an identifier and device information, which is not limited herein. Thus, the first communication unit 22 can communicate with the first playback device 42 to receive the identifier and the device information of the first playback device 42, executes an NFC authentication of the first playback device 42 via the identifier, and recognizes the first playback device 42 via the device information. In the embodiment, the electronic device 20 confirms the identification of the first playback device 42 by using the NFC technology, and the electronic device 20 receives the playback information of the streaming media played by the first playback device 42 via the NFC connection.

In the embodiment, the streaming media is digital media data, and it includes media files, audio files, video files or pictures. In the embodiments, the current playback streaming media includes one or more streaming media, and it includes at least one of media files, audio files, video files or pictures.

In an embodiment, if the first playback device 42 plays multiple streaming media at the same time, when a connection is established between the electronic device 20 and the first playback device 42 via the first communication unit 22, the electronic device 20 displays a menu of the current playback streaming media via a user interface, and the user directly selects one or more streaming media from the menu to receive the playback information, and then the selected streaming media is continuously played. The number of the selected streaming media to be continuously played is not limited herein. The menu is an example of the selection mechanism, which is not limited herein.

The playback information includes the file name of the streaming media, the current playback time point information of the streaming media and the storage address of the streaming media in the media server 30, which is not limited herein. The storage address includes a uniform resource identifier (URI), a digital item declaration language (DIDL) and a transmission format of metadata, and then the browsing process in the DLNA architecture is not needed, and the switching time is shortened.

In the embodiment, the electronic device 20, the media server 30 and the playback devices 40 are respectively connected to the LAN via a same communication platform, and a digital home network which conforms to the DLNA standard is formed. If the electronic device 20 is a portable device, such as a mobile phone, the communication platform can be an application program. If the electronic device 20 is a PC, the communication platform can be a user interface of a player. In other words, in the embodiment, the operating interface is provided according to the type of the electronic device 20.

In the step S306, when a connection is established between the first communication unit 22 of the electronic device 20 and the second playback device 44 of the playback devices 40 based on the second communication protocol, the processing unit 26 transmits the playback information to the second playback device 44 via the first communication unit 22, and then the second playback device 44 continues playing the streaming media according to the playback information.

In detail, in an embodiment, the second communication protocol is the NFC protocol. The processing unit 26 first cuts off the connection between the first communication unit 22 and the first playback device 42, and then a connection is established between the processing unit 26 and the second playback device 44 via the first communication unit 22 based on the NFC protocol. In other embodiments, if the second communication protocol is another communication protocol, such as IR transmission or radio transmission, a connection is directly established between the processing unit 26 and the second playback device 44 via an IR module or a radio transmission module, and the processing unit 26 determines whether to cut off the connection between the first communication unit 22 and the first playback device 42. In an embodiment, the electronic device 20 remotely guides the streaming media to the second playback device 44 for continuous playing, which expands functions.

In an embodiment, when the processing unit 26 receives the playback information via the first communication unit 22, the processing unit 26 continues playing the streaming media according to the playback information, and when a connection is established between the processing unit 26 and the second playback device 44 via the first communication unit 22 based on the second communication protocol, the processing unit 26 updates the playback information according to the current playback time point of the streaming media, and the updated playback information is transmitted to the second playback device 44 via the first communication unit 22. In other words, when the electronic device 20 receives the playback information of the streaming media, it can continue playing the streaming media at its own player (such as a display panel). When a connection is established between the electronic device 20 and the second playback device 44, the connection establishment triggers the updating of the playback information. Then, the electronic device 20 updates the playback information, such as the current playback time point, and switches the streaming media again to the second playback device 44. The second playback device 44 continues playing the streaming media according to the updated time point.

The mechanism of continuing playing the streaming media by the electronic device 20 or the second playback device 44 according to the playback information can be achieved in different ways.

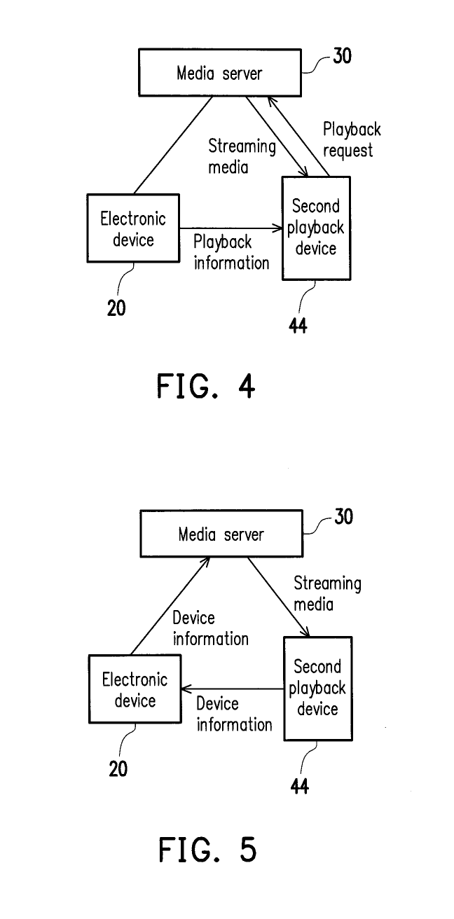

First, in an embodiment, the electronic device 20 transmits the playback information to the second playback device 44, and the second playback device 44 sends a playback request to the media server 20 according to the playback information. Please refer to FIG. 4, in the embodiment, the processing unit 26 of the electronic device 20 transmits the playback information, including the storage address of the streaming media in the media server 20 and the current playback time point information, to the second playback device 44 via the first communication unit 22. Thus, the second playback device 44 can request the media server 30 to provide the streaming media according to the storage address and then continue playing the streaming media according to the time point information.

Please refer to FIG. 5, in the embodiment, the electronic device 20 receives the device information of the second playback device 44 via the connection between the first communication unit 22 and the second playback device 44, and the device information of the second playback device 44 is transmitted to the media server 30 via the second communication unit 24, and then the media server 30 can provide the streaming media to the second playback device 44 according to the device information. The device information is the device identifier of the second playback device 44, and it supports the transmission format of the DLNA standard. Thus, after the media server 30 receives the device information of the second playback device 44, it can search for the second playback device 44 in the LAN. In the embodiment, since the electronic device 20 provides the device information of the second playback device 44 to the media server 30, the streaming media played by the first playback device 42 or the electronic device 20 is guided to the second playback device 44.

In the embodiment, the second playback device 44 is a digital render (such as a smart TV) which passively receives and plays the streaming media. However, the type of the electronic device 20 or the second playback device 44 is not limited.

As stated above, the device information and the playback information can be transmitted between the electronic device 20 and the second playback device 44 via the NFC technology, and the streaming media is guided to the second playback device 44 for continuous playing according to the playback information. Thus, the digital media controller in the DLNA architecture can select the player to play the streaming media via the NFC technology. In the previous embodiment, a connection is established between the electronic device 20 and the second playback device 44. In an embodiment, a connection is also established between the electronic device 20 and the first playback device 42 for continuous playing according to the first communication protocol, which is not limited herein.

In an embodiment, when the electronic device 20 guides the streaming media played by the first playback device 42 to the electronic device 20 or the second playback device 44 for continuous playing, the first playback device 42 still plays the streaming media. In other words, the streaming media is played by the electronic device 20 at the same time. Moreover, the number of the electronic device 20 and the playback devices 40 for playing the streaming media at the same time is not limited herein.

In an embodiment, the electronic device 20 and the media server 30 in the LAN is a same device. Thus, in an embodiment, when a connection is established between the electronic device 20 and the second playback device 44 according to the second communication protocol, the electronic device 20 can directly provide the digital media stored therein to the second playback device 44 in a streaming form.

In the system architecture, the connection established between the first communication unit 22 of the electronic device 20 and each of the playback devices 40, such as the induction of the NFC or locating of IR or radio transmission, can be regarded as a command of switching the streaming media to another device for continuous playing.

In sum, the electronic device and the playback method of the streaming media thereof are applied to an DLNA system, and the NFC technology and other communication protocols are used to transmit the playback information between two devices, such as the current playback time point information of the streaming media and the storage address of the streaming media in the media server. Furthermore, the playback of the streaming media is provided according to the type of the playback device, and thus, the streaming media can be switched between different devices for continuous playing. Consequently, complicated manual settings are not needed, and it does not need to search another device for playback. Additionally, the browsing mechanism of the DLNA architecture is not the only choice, and the media sharing is more convenient.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device, communicating to a media server and a plurality of playback devices via a local area network (LAN), the plurality of playback devices also communicates to the media server via the LAN, and the media server provides streaming media to a first playback device of the plurality of playback devices for playback, the electronic device comprising:
a first communication unit;
a second communication unit communicating to the media server via the LAN; and
a processing unit coupled to the first communication unit and the second communication unit, wherein when a connection is established between the first communication unit and the first playback device based on a first communication protocol, the processing unit receives playback information of the streaming media via the first communication unit, and when the connection is established between the first communication unit and a second playback device of the playback devices based on a second communication protocol, the processing unit transmits the playback information to the second playback device via the first communication unit, and the second playback device continues playing the streaming media according to the playback information.

2. The electronic device according to claim 1, wherein when the processing unit receives the playback information via the first communication unit, the processing unit continues playing the streaming media according to the playback information, and when the connection is established between the processing unit and the second playback device via the first communication unit based on the second communication protocol, the processing unit updates the playback information according to a current playback time point of the streaming media, and transmits the updated playback information to the second playback device via the first communication unit.

3. The electronic device according to claim 1, wherein after the processing unit cuts off the connection between the first communication unit and the first playback device, the connection is established between the processing unit and the second playback device via the first communication unit based on the second communication protocol.

4. The electronic device according to claim 1, wherein the first communication protocol is near field communication (NFC) protocol, and when the first communication unit approaches an NFC unit of the first playback device, the processing unit receives identification data of the first playback device via the first communication unit to establish an NFC connection with the first playback device, and the processing unit receives the playback information of the streaming media via the NFC connection.

5. The electronic device according to claim 1, wherein the playback information comprises current playback time point information of the streaming media and a storage address of the streaming media in the media server.

6. The electronic device according to claim 5, wherein when the connection is established between the first communication unit and the second playback device based on the second communication protocol, the processing unit transmits the playback information of the streaming media to the second playback device via the first communication unit, the second playback device requests the media server to provide the streaming media according to the storage address, and the second playback device continues playing the streaming media according to the current playback time point information.

7. The electronic device according to claim 1, wherein when the connection is established between the first communication unit and the second playback device based on the second communication protocol, the processing unit receives device information of the second playback device via the first communication unit, the processing unit transmits the device information to the media server via the second communication unit, and the media server provides the streaming media to the second playback device according to the device information.

8. A playback method of streaming media, applied to an electronic device, a media server and a plurality of playback devices in a local area network (LAN), the playback devices are connected to the media server via the LAN, and the media server provides the streaming media to a first playback device of the playback devices for playback, the method comprising following steps:
establishing a connection between the LAN and each of the electronic device, the media server and the playback devices;
receiving playback information of the streaming media when the connection is established between the electronic device and the first playback device based on a first communication protocol; and
transmitting the playback information to a second playback device of the playback devices when the connection is established between the electronic device and the second playback device based on a second communication protocol to control the second playback device to continue playing the streaming media according to the playback information.

9. The playback method of the streaming media according to claim 8, wherein after receiving the playback information of the streaming media, the method further comprises:
continuing playing the streaming media according to the playback information;
updating the playback information according to a current playback time point of the streaming media when the connection is established between the electronic device and the second playback device based on the second communication protocol; and
transmitting the updated playback information to the second playback device.

10. The playback method of the streaming media according to claim 8, wherein before establishing the connection between the electronic device and the second playback device based on the second communication protocol, the method further comprises:
cutting off the connection between the electronic device and the first playback device.

11. The playback method of the streaming media according to claim 8, wherein the first communication protocol is near field communication (NFC) protocol, and the step of receiving the playback information of the streaming media further comprises:
receiving identification data of the first playback device when the electronic device approaches the first playback device to establish an NFC connection between the electronic device and the first playback device; and
receiving the playback information of the streaming media via the NFC connection.

12. The playback method of the streaming media according to claim 8, wherein the playback information comprises current playback time point information of the streaming media and a storage address of the streaming media in the media server.

13. The playback method of the streaming media according to claim 12, wherein the step of transmitting the playback information to the second playback device of the playback devices when the connection is established between the electronic device and the second playback device based on a second communication protocol to control the second playback device to continue playing the streaming media according to the playback information comprises:
transmitting the storage address of the streaming media and the current playback time point information to the second playback device and requesting the media server to provide the streaming media by the second playback device according to the storage address; and
continuing playing the streaming media according to the current playback time point information.

14. The playback method of the streaming media according to claim 8, wherein the step of transmitting the playback information to the second playback device of the playback devices when the connection is established between the electronic device and the second playback device based on a second communication protocol to control the second playback device to continue playing the streaming media according to the playback information further comprises:
receiving device information of the second playback device; and
transmitting the device information to the media server and providing the streaming media to the second playback device by the media server according to the device information.
